(19) United States
(12) Patent Application Publication
(10) Pub. No.: US 2016/0196588 A1
(43) Pub. Date: Jul. 7, 2016

(54) INTERACTING METHOD

(71) Applicant: Cho Yi Lin, New Taipei City (TW)

(72) Inventors: Hong Fan Wei, Taipei City (TW); Chia Hao Lee, Taipei City (TW); Cho Yi Lin, Taipei City (TW); Chien Chuan Chen, Taipei City (TW); Yu Shu Hsu, Taipei City (TW); Yu Hao Chang, Taipei City (TW)

(21) Appl. No.: 14/590,110

(22) Filed: Jan. 6, 2015

(51) Int. Cl. G06Q 30/02; G06F 3/0484; G06F 3/0488; H04L 29/08

(52) U.S. Cl. CPC G06Q 30/0277; H04L 67/02; G06F 3/0484; G06F 3/04883

(57) ABSTRACT

An interacting method is used for a electronic apparatus. The interacting method includes the following steps: performing a first application program, triggering a second application program according to a triggering rule when the first application is executed, wherein the first application program and the second application program are displayed on a display area of the electronic apparatus at the same time according to a preset frame arrangement, generating a feedback an input signal of a user interface of the second application program, and performing a preset action according to the feedback.

### BACKGROUND

1. Technical Field

This disclosure generally relates to an interacting method and, more particularly, to an interacting method for an electronic apparatus.

2. Related Art

With the progress of science and technology, electronic devices, such as smart phones, tablet computers, and etc., have become indispensable in daily life. In order to achieve the effect of advertisement, most of the manufacturers add a link corresponding an advertisement in the application program configured in the electronic apparatus, such that the advertisement is displayed when the user operates a certain application program, brows a webpage or watches a movie on the electronic apparatus.

Currently after the electronic apparatus displays the advertisement, the user only has two choices: one is to click the advertisement to link to the advertisement website so as to view the advertisement content, and the other is to close the advertisement. However, in addition to the above two choices, the user can not have any interaction with the advertisement. Therefore, the advertisement display needs improvement.

### SUMMARY

The disclosure provides an interacting method, thereby providing an interaction between the application program and the user for increasing experience firsthand for users.

The disclosure provides an interacting method for an electronic apparatus. The interacting method includes the following steps. A first application program is executed. A second application program is triggered according to a triggering rule when the first application is executed, wherein the first application program and the second application program are displayed on a display area of the electronic apparatus at the same time according to a preset frame arrangement. A feedback is generated according to an input signal of a user interface of the second application program. A preset action is executed according to the feedback.

The disclosure further provides an interacting method for an electronic apparatus. The interacting method includes the following steps. A first application program is executed. Advertisement information is embedded in a first graphic layer of the first application program. An object is embedded in a second graphic layer of the first application program. A preset action is executed according to a change of the object, wherein the second graphic layer is configured on the first graphic layer.

According to the interacting method disclosed in the exemplary embodiments, when the electronic apparatus executes the first application program, the electronic apparatus triggers the second application program, according to the triggering rule, and then generates a feedback according the input signal of the user interface of the second application program and executes the preset action according to the feedback. Additionally, the electronic apparatus embeds the advertisement information in the first graphic layer of the application program and the object in the second graphic layer of the application program, and then executes the action according the change of the object. Therefore, an interaction between the application program and the user is provided and experience firsthand for user is increased.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a flowchart of the interacting method according to a first exemplary embodiment of the disclosure;

FIG. 2A, 2B, 2C, 2D shows an arrangement of the first application program and the second application program on the preset frame arrangement according to a exemplary embodiment of the disclosure;

FIG. 3 shows a flowchart of the interacting method according to a second exemplary embodiment of the disclosure;

FIG. 4 shows a flowchart of the interacting method according to a third exemplary embodiment of the disclosure;

FIG. 5 shows a flowchart of the interacting method according to a fourth exemplary embodiment of the disclosure; and

FIG. 6 shows a flowchart of the interacting method according to a fifth exemplary embodiment of the disclosure.

### DETAILED DESCRIPTION OF THE EMBODIMENTS

Referring to the drawings, embodiments of the present disclosure are described in more detail. The detailed description below is intended as a description of various configurations of the subject technology and is not intended to represent the only configuration in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology. Like components are labeled with identical element numbers for ease of understanding.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substaintial/substaintially” means, within an acceptable error range, the person skilled in the art may solve the technical problem in a certain error range to achieve the basic technical effect. Additionally the term “couple” or “connect” covers any direct or indirect electrically coupling means. Therefore when one device is electrically connected to another device in the context, that connection may be through a direct electrical connection, or through an indirect electrical connection via other devices and connections. The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

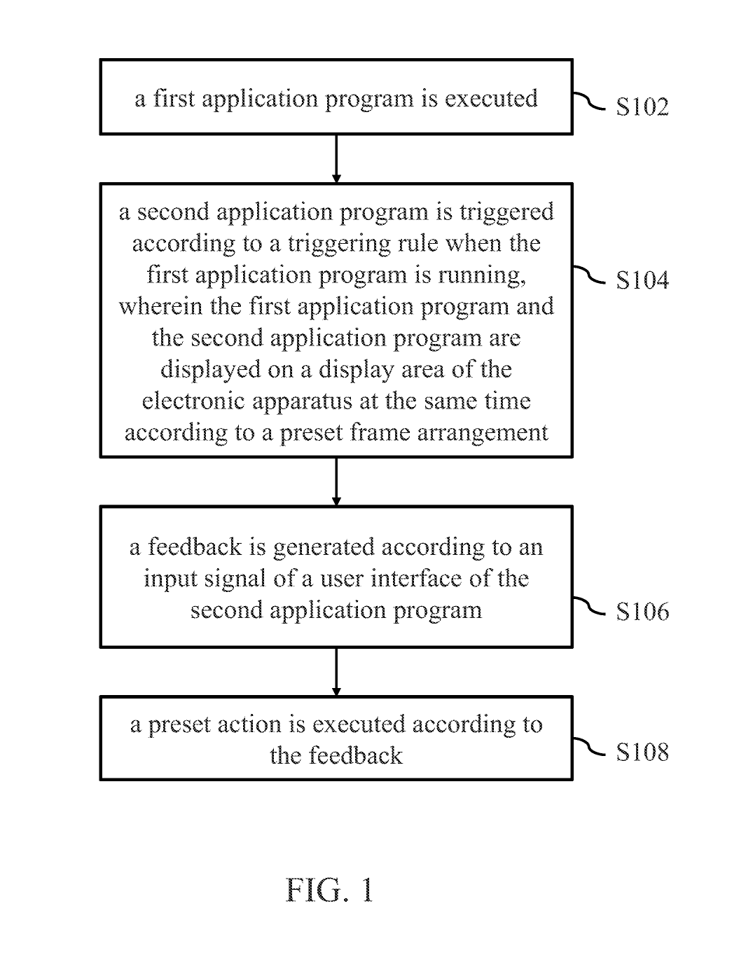

FIG. 1 shows a flowchart of the interacting method according to a first exemplary embodiment of the disclosure. The interacting method of the disclosure is used in an electronic apparatus such as a smart phone, a tablet computer or a smart television. Additionally, an operation system of the electronic apparatus may be, for example, Android or iOS, and it is not limited to the disclosure.

In the step S102, a first application program is executed. That is, the user may operate the electronic apparatus, i.e. the user clicks on the first application built-in or downloaded in the electronic apparatus, such that the electronic apparatus executes the first application program. The first application program may be a daemon program such as a video playing program, a webpage browsing program or a multi-media program.

In the step S104, a second application program is triggered according to a triggering rule when the first application program is running, wherein the first application program and the second application program are displayed on a display area of the electronic apparatus at the same time according to a preset frame arrangement. Preferably, the above second application program may be, for example, an advertisement application program.

For example, the electronic apparatus may set a link or a function corresponding to the second application program in the first application program in advance. Then, when the electronic apparatus executes the first application program, the electronic apparatus may find and call the corresponding second application program through the link or the function set in the first application program, so as to trigger the second application program. A manner of finding and calling the second application program mentioned above may be, for example, similar to a manner of transmitting a parameter via an intent command in the Android system.

Further, in the disclosure, the above triggering rule may be, for example, an active triggering or a passive triggering. The active triggering includes the step of triggering the second application program when a timer counts to a preset time. That is, when the electronic apparatus executes the first application program, the timer disposed in the electronic apparatus starts to count, and when the timer counts to the preset time, such as 2 seconds, the electronic apparatus actively triggers the second application program. Namely, after the electronic apparatus executes the application program for a period of time, the electronic apparatus actively triggers the second application program.

In another embodiment, the passive triggering includes the step of triggering the second application program when a function of the first application program is executed. For example, when the user operates (e.g. hit, click, or tap) a function key (such as pause, play or fast forward and so on) on the first application program, the electronic apparatus triggers the second application program. That is, when the electronic apparatus runs the first application program, the electronic apparatus does not actively trigger the second application program. Instead, the electronic apparatus triggers the second application program by the user executing the function of the first application program.

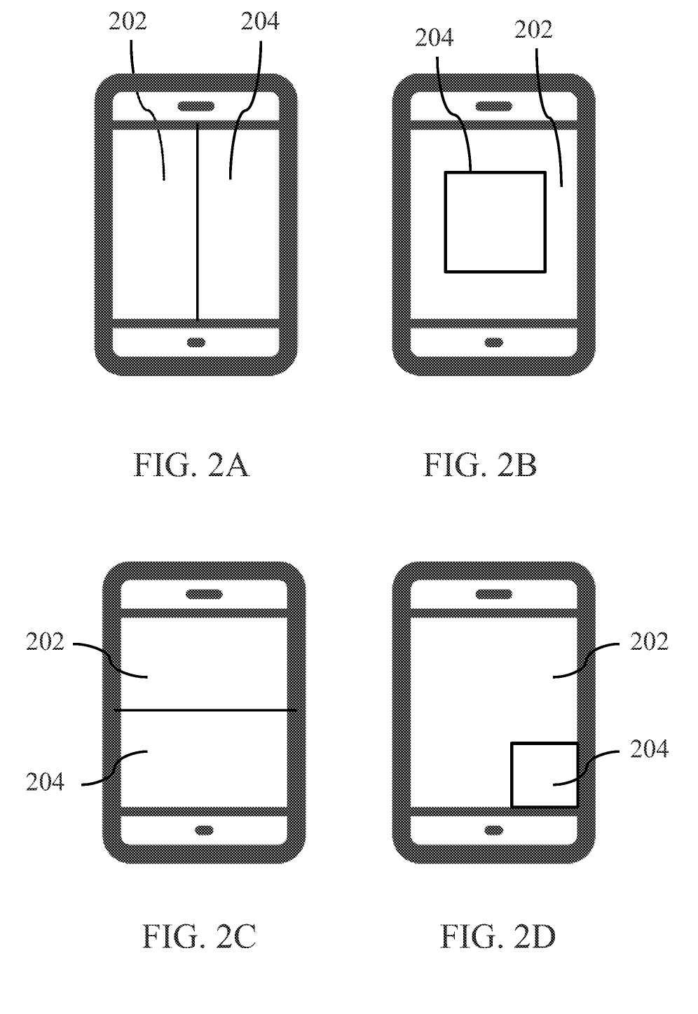

Additionally, the preset frame arrangement includes the first application program 202 and the second application program 204 arranged on the left and right sides in parallel (as shown in FIG. 2A), the second application program 204 overlapped on the first application program 202 (as shown in FIG. 2B), the first application program 202 and the second application program 204 arranged on the top and the bottom (as shown in FIG. 2C), the first application program 202 and the second application program 204 formed a pop up play (as shown in FIG. 2D).

In the step S106, a feedback is generated according to an input signal of a user interface of the second application program. That is, when the second application program is triggered, the second application program provides the user interface to the user, such that the user may input the input signal using the user interface. Correspondingly, the second application program generates the feedback to the user through the user interface. For example, the feedback generated by the second application program may be a change of an object on the user interface. When the user inputs the input signal through the user interface, the object on the user interface changes correspondingly, and the change is fed back to the user through the user interface.

In the step S108, a preset action is executed according to the feedback. That is, the second application program executes the preset action according to the content, magnitude, change, degree of the feedback and so on, so as to guide the user to go to the next operation. For example, when the change of the object on the user interface exceeds seventy percent, the second application program executes the preset action immediately.

In other words, when the user executes the first application program on the electronic apparatus, the second application program is triggered after the user executes a certain function on the first application program or when the first application program has been executed for a period of time. When the second application program is running, the user inputs the input signal through the user interface of the second application program, and the second application program also generates a feedback through the user interface correspondingly, so as to achieve an interaction between the user and the second application program.

In the disclosure, the above input signal may be, for example, a gesture of a user, audio of a user, a touch of a user or a press of a user. That is, the user generates the corresponding input signal using a manner of inputting the gesture, the audio, the touch or the press on the user interface of the second application program displayed on the electronic apparatus, such that the electronic apparatus generates the feedback and further executes the corresponding preset action.

Additionally, the preset action includes at least one of the following conditions: closing the second application program, opening a webpage, switching tasks of the second application program, updating the advertisement information and triggering a third application program.

For example, when the preset action is closing the second application program, the electronic apparatus closes the second application program, and continues executing the first application program on the display area.

When the preset action is opening the webpage, the second application program links to the corresponding webpage accordingly.

When the preset action is switching the tasks of the second application program, the second application program indicates or prompts the corresponding task to the user for a following operation. For example, the task may be a next level of an interacting game. That is, the user must complete the current task, such as pass the ongoing level, so as to go to the next level. Additionally, after the user completes the interacting game, a company releasing/supporting/developing the interacting game may provide, for example, a reward such as credits, virtual treasure and so on to the user.

When the preset action is updating the advertisement information, the second application program updates the advertisement information, and displays the updated advertisement information to user for viewing.

When the preset action is triggering the third application program, the electronic apparatus finds and calls the corresponding third application program through a link or a function set in the second application program, so as to trigger the third application program. The electronic apparatus may set a link or a function of the second application program corresponding to the third application program in advance.

Therefore, the interacting method provided by the disclosure may achieve the interaction between the application program and the user, so as to increase the experience firsthand for user.

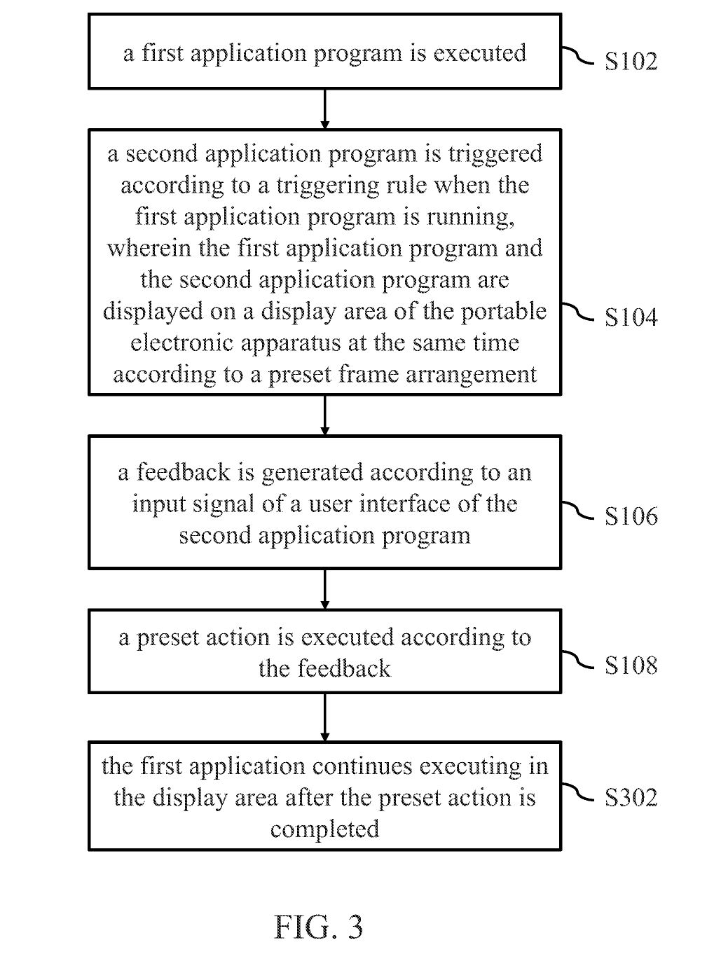

FIG. 3 shows a flowchart of the interacting method according to a second exemplary embodiment of the disclosure. In the embodiment, the description of the steps S102, S104, S106, S108 can be found in the description of the embodiment in FIG. 1. Thus the description is omitted. The embodiment in FIG. 3 further includes the step S302, which is different from the embodiment in FIG. 1.

In the step S302, the first application continues executing in the display area after the preset action is completed. That is, after the preset action interacted between the user and the second application program of the electronic apparatus is completed, the electronic apparatus closes, for example, the second application program, and only displays the first application program on the display area and continues performing the first application program.

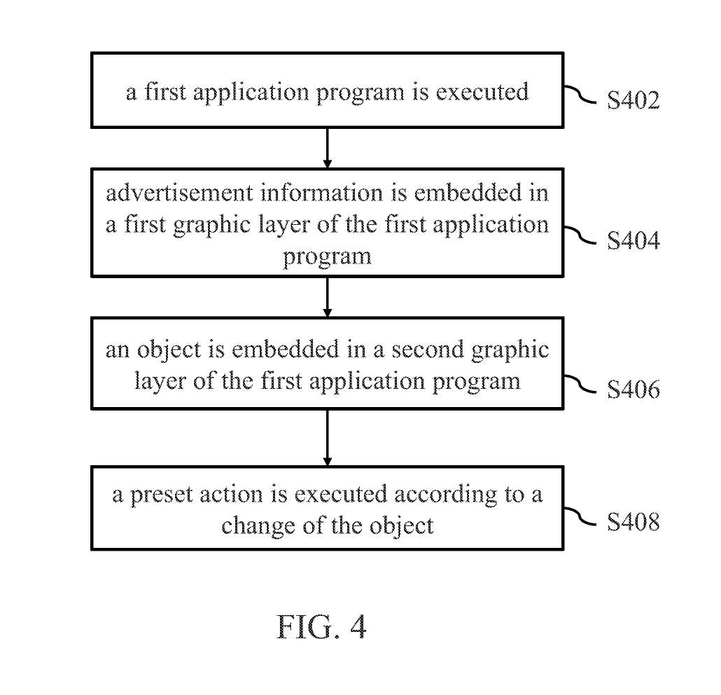

On the other hand, when the second application program is an advertisement application program, the second application program in the step S104 may include other steps, as shown in FIG. 4. FIG. 4 shows a flowchart of the interacting method according to a third exemplary embodiment of the disclosure. The interacting method of the disclosure is used in the electronic apparatus such as a smart phone, a tablet computer or a smart television. Additionally, an operation system of the electronic apparatus may be, for example, Android or iOS, and it is limited to limit the disclosure.

In the step S402, a first application program is executed. In this embodiment, this first application may, for example, an advertisement application program and this first application also may, for example, be the second application program described in FIG. 1.

In the step S404, advertisement information is embedded in a first graphic layer of the first application program. The advertisement information may be, for example, an image file or a video file, and it is not limited to the disclosure.

In the step S406, an object is embedded in a second graphic layer of the first application program. The second graphic layer is, for example, configured on the first graphic layer, such as the second graphic layer is covered or overlapped on the first graphic layer. Additionally, the object may be, for example, a game object.

In the step S408, a preset action is executed according to a change of the object. The change of the object may be, for example, generated by a gesture of a user, audio of a user, a touch of a user or a press of a user. In this embodiment, the change of the object may be, for example, the feedback of the above steps S106 and S108.

For example, when the advertisement application program is executed, the advertisement application program has the advertisement image file or the advertisement video file embedded in the first graphic layer as a background of the advertisement application program. Then, the advertisement application program has the game object embedded in the second graphic layer. Preferably, the second graphic layer is overlapped on the first graphic layer. In other words, the user may operate the game object in the background of the advertisement picture. When the user draws a circle or an arbitrary shape on the advertisement application program of the electronic apparatus through the gesture, touch or press, the advertisement application program has a change of the game object occurring on the second graphic layer, and then the advertisement application program goes to the next level or executes the above preset action according to the change of the game object. That is, besides the user may view the advertisement information embedded in the first graphic layer of the advertisement application program through the advertisement application program, the user may further perform the corresponding operation on the game object embedded in the second graphic layer of the advertisement application program, for example, through the gesture of the user, the audio of the user, the touch of the user or the press of the user. The advertisement application program generates the change of the game object and feeds it back to the user, and executes the corresponding preset action according the change of the game object. Therefore, an interaction between the advertisement application program and the user is achieved and the experience firsthand for user is increased.

Additionally, the description of the preset action can be found in the description of the embodiment in FIG. 1, and thus is omitted herein.

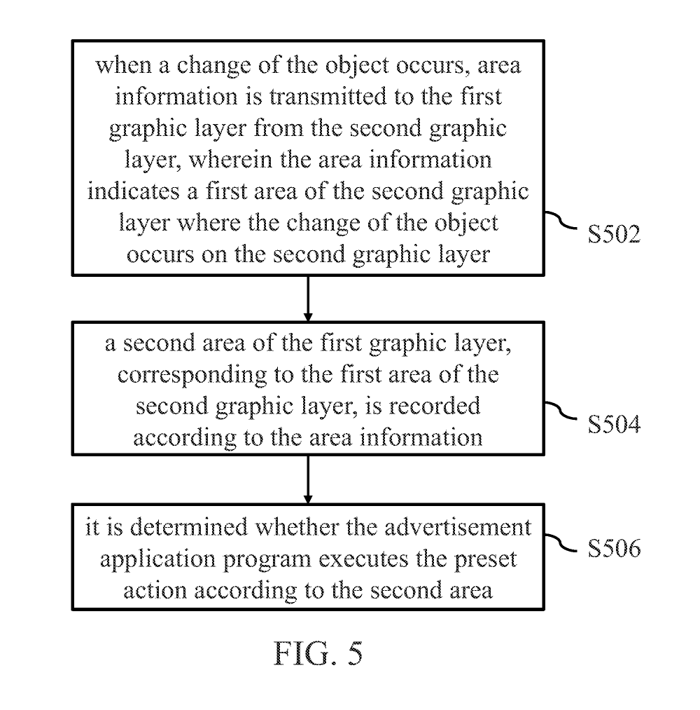

Moreover, the step S408 of the disclosure may include other steps, as shown in FIG. 5. FIG. 5 shows a flowchart of the interacting method according to a fourth exemplary embodiment of the disclosure.

In the step S502, when a change of the object occurs, area information is transmitted to the first graphic layer from the second graphic layer, wherein the area information indicates a first area of the second graphic layer where the change of the object occurs on the second graphic layer. In the step S504, a second area of the first graphic layer, corresponding to the first area of the second graphic layer, is recorded according to the area information. In the step S506, it is determined whether the advertisement application program executes the preset action according to the second area.

That is, the user may performs an operation (e.g. touch or press) on the first area of the second graphic layer, such that the change of the object embedded in the second graphic layer occurs on the first area and generates the area information of the first area. Then the second graphic layer transmits the area information to the first graphic layer. Afterward the first graphic layer records the second area according to the area information, so as to determine whether the advertisement application program should execute the preset action. Therefore, an interaction between the advertisement information embedded in the first graphic layer and the object embedded in the second graphic layer is achieved.

Additionally, the coordinate systems on the first area of the second graphic layer and the second area of the first graphic layer may be the same or different. When the coordinate systems on the first area of the second graphic layer and the second area of the first graphic layer are the same, the calculation for the coordinate translation is not necessary. Moreover, the area information may be, for example, stored in a memory of the electronic apparatus.

In the embodiment, the step S506 includes the step of the preset action being executed by the advertisement application program when the second area occupies the first graphic layer to a specific ratio. For example, the user draws a circle or an arbitrary shape on the advertisement application program, the advertisement application program has the change of the game object occurring on the second graphic layer (such as generates a mask on the second graphic layer). At this time, the second graphic layer transmits the area information of the drawn area to the first graphic layer. The first graphic layer records the second area according to the area information. When the advertisement application program determines that the game is completed or passed according to the second area of the first graphic layer, for example the advertisement application program determines that the game is passed if the second area of the first graphic layer occupies the first graphic layer (i.e. the advertisement image file) to seventy percent, the advertisement application program goes to the next level or executes the above preset action.

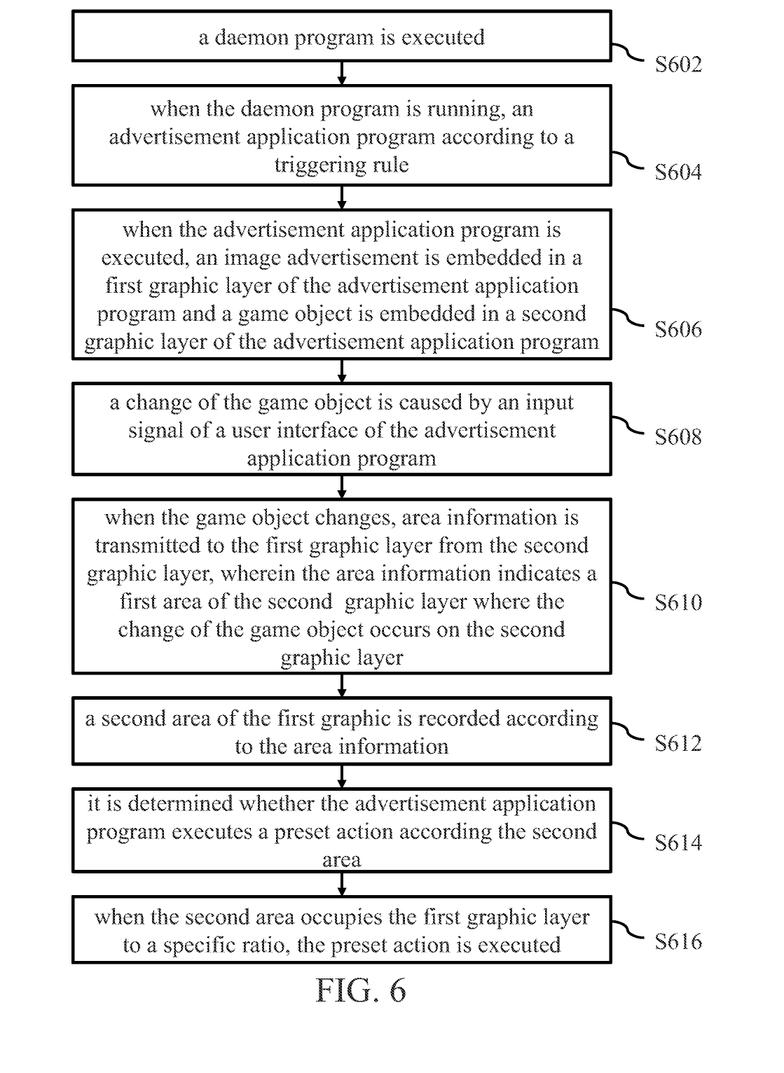

FIG. 6 shows a flowchart of the interacting method according to a fifth exemplary embodiment of the disclosure. The interacting method of the disclosure is used in the electronic apparatus such as a smart phone, a tablet computer or a smart television. Additionally, an operation system of the electronic apparatus may be, for example, Android or iOS, and it is not limited to the disclosure.

In the step S602, a daemon program such as a video playing program, a webpage browsing program or a multi-media program is executed. In the step S604, when the daemon program is running, an advertisement application program according to a triggering rule (an active triggering or a passive triggering). In the step S606, when the advertisement application program is executed, an image advertisement is embedded in a first graphic layer of the advertisement application program and a game object is embedded in a second graphic layer of the advertisement application program, wherein the second graphic layer is configured on the first graphic layer.

In the step S608, a change of the game object is caused by an input signal of a user interface of the advertisement application program. In the step S610, when the game object changes, area information is transmitted to the first graphic layer from the second graphic layer, wherein the area information indicates a first area of the second graphic layer where the change of the game object occurs on the second graphic layer.

In the step S612, a second area of the first graphic layer, corresponding to the first area of the second graphic layer, is recorded according to the area information.

In the step S614, it is determined whether the advertisement application program executes a preset action according the second area. In the step S616, when the second area occupies the first graphic layer to a specific ratio, the preset action is executed.

The detailed embodiment of the interacting method in FIG. 6 may be found in the description of the above embodiment, and thus is omitted.

According to the interacting method of the above-mentioned embodiments, when the electronic apparatus executes the first application program, the electronic apparatus triggers the second application program, according to the triggering rule, and then generates a feedback according the input signal of the user interface of the second application program. Further, the electronic apparatus executes the preset action according to the feedback. Additionally, the electronic apparatus embeds the advertisement information in the first graphic layer of the application program and the object in the second graphic layer of the application program, and then executes the preset action according the change of the object. Therefore, an interaction between the application program and the user is provided and an experience firsthand for user is increased.

Although the disclosure has been explained in relation to its preferred embodiment, it does not intend to limit the disclosure. It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. An interacting method, used for a electronic apparatus, comprising:
executing a first application program;
triggering a second application program according to a triggering rule when the first application is running, wherein the first application program and the second application program are displayed on a display area of the electronic apparatus at the same time according to a preset frame arrangement;
generating a feedback according to an input signal of a user interface of the second application program; and
performing a preset action according to the feedback.

2. The interacting method as claimed in claim 1, wherein the step of triggering the second application program comprising:
embedding advertisement information in a first graphic layer of the second application program; and
embedding an object in a second graphic layer of the second application program.

3. The interacting method as claimed in claim 2, wherein the feedback is a change of the object.

4. The interacting method as claimed in claim 1, wherein the first application program is a video playing program, a webpage browsing program or a multi-media program.

5. The interacting method as claimed in claim 1, wherein the second application program is an advertisement application program.

6. The interacting method as claimed in claim 1, wherein the input signal is a gesture of a user, audio of a user, a touch of a user or a press of a user.

7. The interacting method as claimed in claim 1, wherein the preset action comprises at least one of the following conditions: closing the second application program, opening a webpage, switching tasks of the second application program, updating the advertisement information and triggering a third application program.

8. The interacting method as claimed in claim 1, further comprising:
continuing executing the first application program in the display area after the preset action is completed.

9. The interacting method as claimed in claim 1, wherein the triggering rule comprises an active triggering or a passive triggering.

10. The interacting method as claimed in claim 9, wherein the active triggering comprises the step of triggering the second application program when a timer counts to a preset time, and the passive trigger comprises the step of triggering the second application program when a function of the first application program is executed.

11. The interacting method as claimed in claim 1, wherein the preset frame arrangement comprises the first application program and the second application program arranged on the left and right sides in parallel, the second application program overlapped on the first application program, the first application program and the second application program arranged on the top and the bottom, the first application program and the second application program formed a pop up play.

12. An interacting method, used for an electronic apparatus, comprising:
executing a first application program;
embedding advertisement information in a first graphic layer of the first application program;
embedding an object in a second graphic layer of the first application program; and
performing a preset action according to a change of the object;
wherein the second graphic layer is configured on the first graphic layer.

13. The interacting method as claimed in claim 12, wherein the advertisement information is an image file or a video file.

14. The interacting method as claimed in claim 12, wherein the object is a game object.

15. The interacting method as claimed in claim 12, wherein the change of the object is generated by a gesture of a user, audio of a user, a touch of a user or a press of a user.

16. The interacting method as claimed in claim 12, wherein the preset action comprises at least one of the following conditions: closing the first application program, opening a webpage, switching tasks of the first application program, updating the advertisement information and triggering a second application program.

17. The interacting method as claimed in claim 12, wherein the step of performing the preset action according to the change of the object comprising:
transmitting area information to the first graphic layer from the second graphic layer when a change of the object occurs, wherein the area information indicates a first area of the second graphic layer where the change of the object occurs on the second graphic layer;
recording a second area of the first graphic layer, corresponding to the first area of the second graphic layer, according the area information; and
determining whether the first application program executes the preset action according to the second area.

18. The interacting method as claimed in claim 12, wherein the step of determining whether the first application program executes the preset action according to the second area comprising:
executing the preset action when the second area occupies the first graphic layer to a particular ratio.
